(19) United States
(12) Patent Application Publication
(10) Pub. No.: US 2012/0188053 A1
(43) Pub. Date: Jul. 26, 2012

(54) System and method for monitoring patients that perform a medical self-check

(75) Inventors: Antonio Talluri, Bagno a Ripoli (FI) (IT); Jörg Marris, Konigstein (DE)

(73) Assignees: AKERN S.R.L., Pontassieve (FI) (IT); Jörg Marris, Koningstein (DE)

(21) Appl. No.: 13/188,741

(22) Filed: Jul. 22, 2011

(30) Foreign Application Priority Data
Aug. 11, 2010 (EP) 10425273.9

(51) Int. Cl. G06F 7/04

(52) U.S. Cl. 340/5.8

(57) ABSTRACT

A system for monitoring patients that perform a medical self-check includes a piece of equipment having a data entry unit, through which a user can enter one or more data; a user identification unit having a mother board configured to request a univocal identification datum and verify the identification entered by the user after the request; a clinical data acquisition unit configured to acquire one or more clinical data of the user after a positive user identification; a mobile telephony system; and at least one, preferably a plurality of diagnostic centers located in different parts and placed in communication with the piece of equipment through the mobile telephony system such that, in use, the piece of equipment transmits the data acquired through the mobile telephony system to a diagnostic center, so that the center can monitor and file such data.

### TECHNICAL FIELD

The present invention relates to the technical field of self-check medical instruments.

In particular, the present invention relates to a system and related method of use that allows, following the identification of a patient, the acquisition of multiple clinical data of the patient and the transmission of such data to a specific processing and monitoring center.

### BACKGROUND ART

Equipment suitable for medical self-check is increasingly common in Italy. Such equipments can be used at home or can in public places, such as pharmacies.

This type of equipment includes equipment for measuring and checking pressure or body weight, which is very common.

The same applicant has also filed a patent application in Italy titled “A procedure and a home device for self-checking the hydration level of a person,” having publication number ITFI20050202, wherein equipment is described that enables a patient to monitor the correct hydration status of his body.

That invention describes a compact piece of equipment, which can measure body reactance Xc. To that aim, that equipment, shown in FIG. 1, is provided with a generator configured to generate a reference signal of alternate voltage at 50 Khz that is emitted into a body section through a pair of plates 21 and 23. The signal goes through the body from plates 21 and 23 to plates 22 and 24 or rather from the fingertip of the thumb toward the fingertips of the other fingers of the hand that lean on plates 22 and 24. A discriminator calculates the deviation of the input signal (the one emitted from the plates 21, 23) with respect to the output signal (the one that arrives at the plates 22, 24) after having gone through such body part. A calculation circuit calculates, on the basis of the said variation, the reactance value, showing it on a display.

The user had been previously instructed by a specialized center on the maximum variations that are allowed and that are representative, in accordance with known formulas, of an equivalent variation in the specific hydration status of the user.

In view of the above, various technical drawbacks are evident.

In the first place, no single piece of equipment is currently available that can acquire and process multiple sets data in order to provide the user with a complete case history. Only single machines exist, each one suitable for checking of a single parameter of the patient (for example to check pressure or to monitor body hydration through the calculation of reactance Xc). The patient is therefore forced to perform multiple checks in order to acquire a set of clinical data of his interest, which is evidently a disadvantage for the patient.

Moreover, it is clear that present self-check machines, being directed to persons not necessarily specialized in the medical field, cannot provide complex clinical data, which inherently require medical interpretation. In that respect, self-check machines are necessarily limited to monitoring a few types of parameters.

Based on the foregoing, it is clear that creating a complete case history always requires the intervention of competent medical staff as well as specialized machines. This forces the patient to continuous visits to specialized centers, which causes significant inconveniences.

Moreover, the user is not always able to assess his own data that he has acquired, and many times the risk is present of underestimating clinical situations that would deserve at least a monitoring by specialized medical staff.

### DISCLOSURE OF THE INVENTION

It is an object of the present invention to provide a patient monitoring system that solves at least in part the above-mentioned drawbacks.

In particular, it is an object of the present invention to provide a patient monitoring system which, while maintaining the characteristics and comfort of self-check, enables a user to acquire multiple types of information that can be assessed in real time by specialized staff, such to create a complete case history and, at the same time, continuous monitoring.

It is an object of the present invention to provide a patient monitoring system which, though maintaining the features of self-check, provides for an immediate specialized intervention when required without leaving the result to the free interpretation of the patient.

These and other objects are achieved through a system as described hereinafter.

A system 1 according to the invention includes a piece of equipment 2, through which one or more clinical data can be obtained of a patient that performs his routine self-check, for example at home or in an equipped pharmacy. In such a case, the equipment is provided with appropriate data entry-data means, for example a keyboard 5 or an audio/receiver system configured to capture the user's voice, through which the user can enter one or more data into equipment 2.

Equipment 2 is also provided with user identification means that include a mother board 6 configured to request a univocal user identification datum and to verify the identification entered by the user after that request.

In such a manner, the user through keyboard 5 (or equivalent system) enters the personal identification datum in such a way that, once the inserted datum is verified to be correct, the procedure can continue.

Equipment 2 is further provided with clinical data acquisition means 3, 4, 11, 12, 13, 14 configured to acquire one or more user clinical data after positive identification.

Equipment 2 is also provided with a mobile telephony system 8, 9 in communication with one or more receiving diagnostic centers 20 in different locations.

In such a manner, in use, equipment 2 transmits the acquired clinical data that relates to the user through mobile telephony system 8, 9 to one of diagnostic centers 20 so that the center can monitor/file such data. The clinical data can be multiple and include, for example, body resistance and reactance values as well as body pressure values, biometrical data in general, body weight, etc.

It is now clear that all the objects of the invention have been achieved. In particular, it is clear that, while maintaining the comfort of a home self-check, it is now possible to have a continuous distance monitoring of the user by expert medical staff that manages the diagnostic center, as if the check was performed at a specialized center.

Moreover, the big quantity of clinical data that can be acquired can provide a complete case history not limited exclusively to just the body hydration level.

In that sense, the medical staff can intervene in different ways at the same time.

In one embodiment, the data entry-data means includes a keyboard 5.

In one embodiment, the identification of the user takes place through a comparison, by means of a processor 11, of an identification datum entered by the user against a reference datum of the user memorized in a memory 14, 15.

In one embodiment, the clinical data acquisition means include two pairs of electrodes 3, 4 that can be grasped by the user and can emit an entering voltage, and can detect a voltage exiting from the user's body such that a processor 11 calculates body resistance R and reactance Xc of the patient based on the detected difference in voltage.

In one embodiment, the data acquisition means include one or more specific questions elaborated by the processor 11, which the user answers through the data acquisition means, preferably through keyboard 5, such that the data are entered into the system.

In one embodiment, a display shows the data requested by the equipment to the user in such a way that the user can appropriately enter them, for example, the questions the patient must answer or the initial identification data.

In one embodiment, a flash memory in included where all the acquired data are memorized before sending to a diagnostic center 20.

In one embodiment, diagnostic centers 20 are provided with a telephony system in communication with telephony system 8, 9 of equipment 2 and with a server provided with a software suitable for processing and filing the received data.

In such a manner, the staff of the diagnostic center can establish a contact directly with the patient.

In one embodiment, the server is configured to detect the status of body hydration on the basis of the received values of resistance and reactance.

The present invention also includes a method of monitoring patients that perform a medical self-check through self-check equipment 2. In one embodiment, the method includes the following steps:

Entering at least one user identification datum into equipment 2 and subsequently identifying the user by comparing the datum entered by the user with a reference datum memorized in equipment 2;

In case of positive identification of the user, acquiring one or more clinical data of the patient;

Sending the acquired said data through mobile telephony system 8, 9 to a diagnostic center 20;

Receiving the data by the diagnostic center through a telephony system and subsequently processing/filing the data through a server such that staff can use such data when needed.

In one embodiment, the entry operation of at least one identification datum is performed through keyboard 5 of equipment 2, through which the user enters a personal identification datum, such as a password and/or a User ID, into processor 11.

In one embodiment, the operation of user identification includes a comparison through processor 11 between the datum entered by the user and a user recognition datum memorized on memory 14, 15 of the equipment.

In one embodiment, the operation of data acquisition includes only one of two options or a combination of two options:

Detection of the patient's resistance R and reactance Xc value through electrodes 3, 4 that are grasped by the user to inject an entering tension and detect an exiting tension through the user's body, such that processor 11 calculates body resistance R and reactance Xc of the patient on the basis of the detected difference in voltage;

Acquisition of one clinical data of the patient by showing with a display 16 one or more questions elaborated by processor 11, to which the patient can answers through the keyboard so that his answers can be acquired by processor 11.

In one embodiment, the operation of sending the acquired data includes the sending of a short message service (SMS) containing the data to a chosen diagnostic center.

In one embodiment, following the reception of the data, the user can directly contact diagnostic center 20 through a SMS, a telephone call or a message sent through the display of the equipment.

### BRIEF DESCRIPTION OF THE DRAWINGS

Further features and advantages of a system and method according to the invention will become clearer through the description of preferred embodiments, intended to illustrate but not to limit, with reference to the enclosed drawings, wherein:

FIG. 1 shows a piece of equipment for monitoring body hydration level in accordance with the prior art;

FIG. 2 shows a block diagram of a system 1 according to invention;

FIG. 3 shows an perspective view of the present equipment that illustrates the grasping of electrodes 3 and 4;

FIG. 4 shows the evaluation of body resistance and reactance evaluation through the passage of current between electrodes 3 and 4;

FIG. 5 shows a block diagram of a method according to the invention.

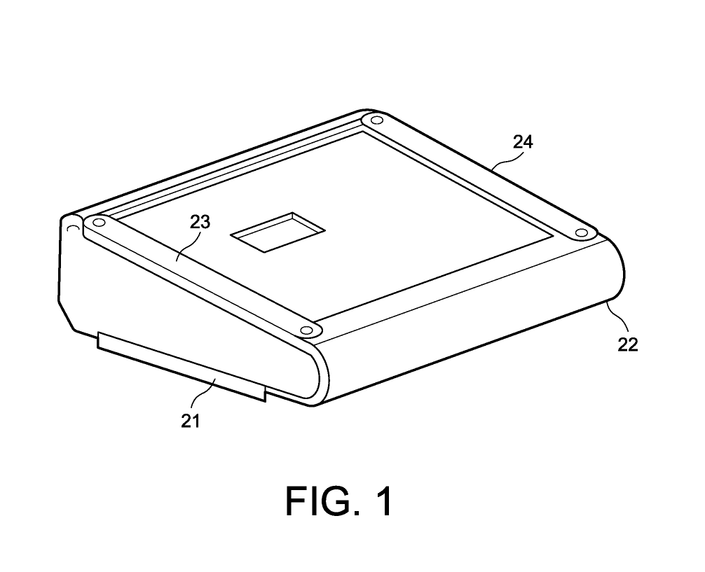

### DESCRIPTION OF SOME PREFERRED EMBODIMENTS

Detailed descriptions of embodiments of the invention are provided herein. It is to be understood, however, that the present invention may be embodied in various forms. Therefore, the specific details disclosed herein are not to be interpreted as limiting, but rather as a representative basis for teaching one skilled in the art how to employ the present invention in virtually any detailed system, structure, or manner.

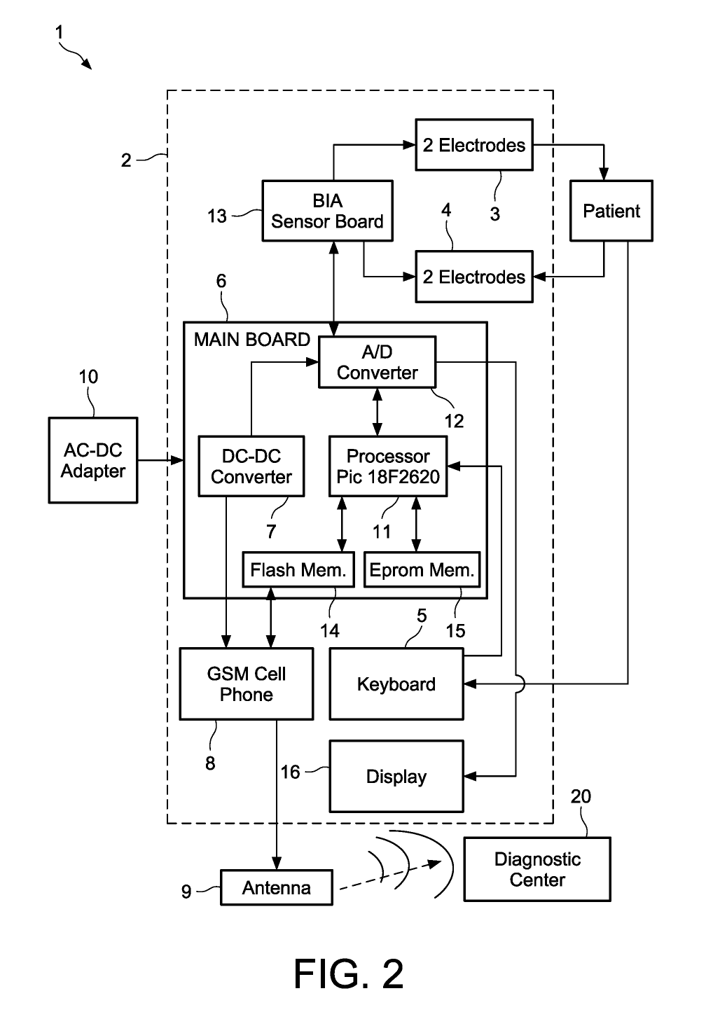

FIG. 2 is a block diagram that illustrates a piece of system 1 in a preferred embodiment of the invention.

The block diagram shows that system 1 is provided with two pairs 3, 4 of electrodes, in order to assess values of body resistance R and reactance Xc values which, as better explained below, will be interpreted by specialized staff, for example, to determine body hydration status of a person.

The box in dotted lines encloses all the essential components of equipment 2.

In particular, a keyboard 5 is shown, through which the patient can interact with system 1 to enter specific requested data. Keyboard 5, although represented in the block diagram as directly integrated within the structure of the equipment 2, can instead be arranged externally and be connected through ordinary electrical wiring. The block diagram also shows with an arrow line the connection between the patient and the keyboard 5 in order to exemplify schematically the machine/patient interaction.

Still with reference to the block diagram of FIG. 2, there is shown the connection between keyboard 5 and mother board 6 of equipment 2, particularly through processor 11, which contains all the basic electronic elements to perform the below described functions. In particular, there is shown a connection between keyboard 5 and processor 11 of the mother board, and FIG. 2 further shows with an arrow line the physical and communication connection between keyboard 5 and mother board 6 through the processor 11.

Equipment 2 also includes a AD-DC transformer 10 configured to provide a stable voltage of 12 V to mother board 6 to feed the operation of all components. Mother board 6, in turn, includes an additional DC-DC transformer 7, which simultaneously provides a first voltage of 9V, intended for some components suitable for functioning with such voltage, and a second voltage of 5V, intended for other components suitable for working with the this second voltage.

In particular, transformer 7 feeds on one side a GSM mobile telephone 8 (which may be configured to transmit and receive data) connected to an emitting/receiving antenna 9. On the opposite side transformer 7 feeds processor 11, preferably of the Pic 18F2620 type, through a A/D converter 12 (analogical/digital converter).

A/D converter 12 puts a sensor 13 in communication with processor 11 in such a way that sensor 13 can measure the difference in voltage between the ends of electrodes 3, 4, and processor 11 can receive and elaborate through converter 12 such information in order to obtain the values of body resistance R and reactance Xc for the person through an appropriate software that implements calculation formulas known in the art.

Still with reference to FIG. 2, two memories 14, 15 are also included. A first memory 14 is of the volatile type, while the second memory 15 is of the permanent type. The memories are connected to processor 11 such that the data processed by the processor can be appropriately memorized.

A/D converter 12 and processor 11 are also connected to display 16 for a display of the data.

Lastlt, the diagram of FIG. 2 shows a data collection and processing center 20, for example a medical center provided with an appropriate receiving system, in communication with equipment 2 through mobile telephone 8. In particular, FIG. 2 shown an exchange of information from antenna 9 to chosen center 20 and possibly vice versa.

Data collection and processing center 20, as described below, is equipped not only with a telephony communication system in communication that can connect with equipment 2, but also with appropriate servers that include a software configured to process the received data using formulas known in the art.

In other embodiments, system 1 may include a plurality of pieces of equipments 2 placed in the territory (both in homes and in public places such as pharmacies) and one or more diagnostic centers 20 in communication with such equipments.

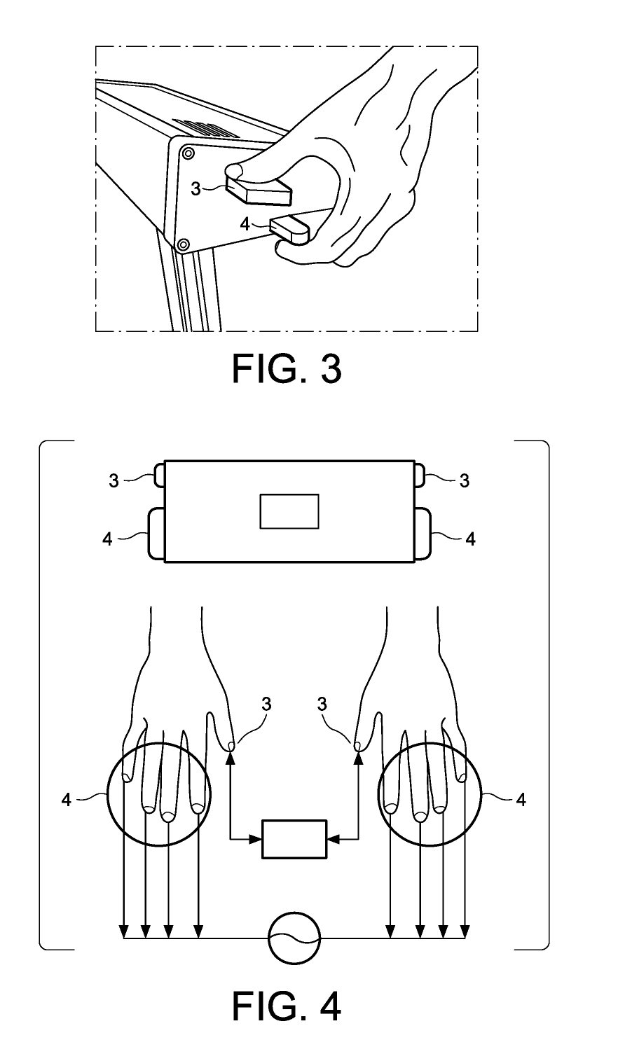

FIG. 3 illustrates a possible arrangement of the pairs of electrodes 3 and 4, while FIG. 4 shows the current flow passing through the fingertips of the patient by means of electrodes 3 and 4 in such a way as to assess body resistance and reactance of the patient.

Having structurally described all the basic elements of a system according to invention, a method of use will be described hereinafter.

A patient that wishes to perform a self-check activates equipment 2. That equipment may be owned by the patient or can be provided in a public place such as a pharmacy.

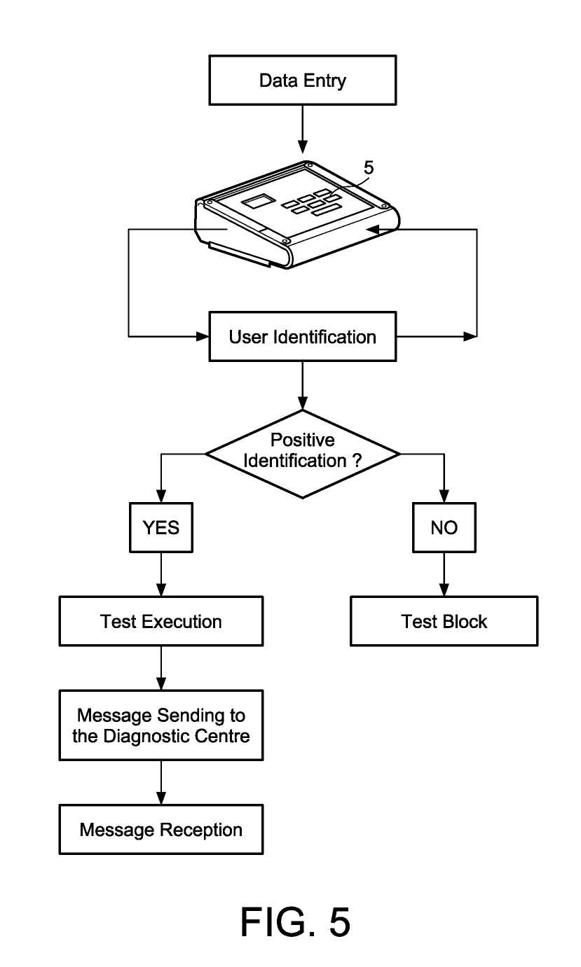

As shown in the flow chart of FIG. 5, in a first step the univocal identification of the patient is performed. In that sense, equipment 2 is set, through processor 11 and display 16, to request the entry of an identification datum. Through keyboard 5, the patient enters into mother board 6, in particular into the processor 11, such datum, for example a password and/or a User ID. Processor 11 executes the identification of the user, which includes the comparison of the identification data entered by the patient with the data stored in the memory, in particular in permanent memory 15, in such a way as to approve the continuation of the procedure. In that sense, when an identification code is lacking, the check cannot be continued and the procedure is interrupted.

In case of positive identification, the patient can continue with the self-check procedure.

The self-check procedure includes a calculation of resistance R and reactance Xc of the patient through the injection of current in the body by means of electrodes and the processing of such data by processor 11, as per FIGS. 3 and 4.

Processor 11 is also programmed to request further information from the patient that may be useful to specialized staff for the assessment of a general or specific case history. Therefore, the patient can, through keyboard 5, enter the data that are requested to him on the display. These data can comprise, for example, age or body weight, as well as other specific pieces of information to which the patient can answer, for example, through a (Yes) or (No) (for example, whether the patient has recently felt ill or which his food habits are). The questions can be similar to those that a doctor would pose to a patient during an examination.

Once such data acquisition phase is completed, the data is memorized on volatile memory 14 such that processor 11 can control the sending of a telephonic SMS through telephone 8 and antenna 9. The SMS contains all the acquired information, which is thus sent to one or more diagnostic centers 20 located within the territory.

The permanent memory, apart from containing the identification of each registered patient in order to start the procedure, can also contain, for each patient, the telephone number of the center to which he is assigned.

Center 20 that receives such data in substantially real time can now, through its own servers, memorize and process the data at the discretion of the center's staff.

For example, the chosen doctor can use the received resistance and reactance values to calculate and monitor the hydration level of the person. Likewise, a cardiologist could interpret other data extrapolated through specific answers entered by the patient to assess general cardiac status, while a nutritionist could make his assessment on the basis of data such as weight and food habits. In any case, such data is available to specialized staff that can interpret and use them as they deem best.

The diagnostic center is furnished with a telephony system able to communicate with equipment 2, from which it has received the information.

This allows, in multiple ways, to intervene in real time in the event that the acquired data show particularly worrisome anomalies.

For example, in a particularly serious case, an operator can inform the patient by telephone or the public place where the equipment is located in order to instruct him on the procedure to be followed and, if necessary, calm him down.

In less serious cases, for example, a signal can be sent by the diagnostic center to equipment 2 which, always through processor 11, would show on the display a message that is addressed to the patient.

In other cases, the sending of an SMS can be configured, which indicates the result of the exam and suggests further actions such as, for example, making an appointment with a doctor.

It is therefore clear that the above described system, while leaving unaltered all the advantages obtained through self-check, allows a monitoring and processing of the data by specialized staff exactly as if the check was being performed in a specialized diagnostic center.

Moreover, such data, thus arranged, are suitable for a cross-check between different specialists for the purpose of building a complete case history.

While the invention has been described in connection with the above described embodiments, it is not intended to limit the scope of the invention to the particular forms set forth, but on the contrary, it is intended to cover such alternatives, modifications, and equivalents as may be included within the scope of the invention. Further, the scope of the present invention fully encompasses other embodiments that may become apparent to those skilled in the art and the scope of the present invention is limited only by the appended claims.

The invention claimed is:

1. A system for monitoring a patient that performs a self-check comprising:
a piece of equipment comprising:
a data entry unit, through which a user can enter one or more data into the piece of equipment;
a user identification unit comprising a mother board configured to request the user to enter a univocal user identification datum and verify the entered user identification datum;
a clinical data acquisition unit configured to acquire one or more user clinical data after positive user identification;
a mobile telephony system; and
one or more diagnostic centers placed in different locations and in communication with the piece of equipment through the mobile telephony system,
whereby, in use, the piece of equipment transmits the acquired clinical data through the mobile telephony system to at least one of the one or more diagnostic centers to monitor and file the clinical data.

2. The system of claim 1, wherein the said data entry unit comprises a keyboard.

3. The system of claim 1, wherein user identification takes place by comparing, with a processor, the entered user identification datum with a user reference datum stored in a memory.

4. The system of claim 3, wherein the clinical data acquisition unit comprises two pairs of electrodes suitable for grasping by the user and configured to provide an entry voltage and detect an exit voltage from the user's body, such to enable the processor to calculate body resistance and reactance of the user based on a difference between entry and exit voltage.

5. The system of claim 3, wherein the data acquisition unit is configured to provide the user with one or more specific questions elaborated by the processor, to which the user answers through the data entry unit, whereby the piece of equipment acquires the one or more data.

6. The system of claim 1, further comprising a display that allows a display of data requested to the user by the piece of equipment, such to enable the user to enter the requested data.

7. The system of claim 1, further comprising a volatile memory into which the clinical data are memorized before sending to the diagnostic center.

8. The system of claim 1, wherein the one or more diagnostic centers are equipped with telephony systems in communication with the telephony system of the piece of equipment and with a server provided with software suitable for processing and filing the clinical data.

9. The system of claim 8, wherein the server is configured to detect body hydration status based on received resistance and reactance values.

10. A method of monitoring a patients performing a medical self-check through a self-check piece of equipment, the method comprising the steps of:
entering at least one identification datum into a piece of equipment;
identifying a user by comparing the entered at least one datum with a reference datum memorized in the piece of equipment;
in case of positive identification of the user, acquiring one or more clinical data of the user;
sending the acquired clinical data through a mobile telephony system to a diagnostic center;
receiving the clinical data by the diagnostic center through a telephony system; and
processing and filing the one or more clinical data through a server such that staff of the diagnostic center is enabled to use the clinical data.

11. The method of claim 10, wherein the step of entering at least one identification datum is performed through a keyboard of the piece of equipment, through which the user enters the at least one identification datum into a processor.

12. The method of claim 11, wherein the step of identifying a user comprises comparing, through the processor, between the at least one identification datum entered by the user with a user recognition datum stored in the memory of the piece of equipment.

13. The method of claim 11, wherein the step of acquiring one or more clinical data comprises one or more of:
detecting resistance and reactance values of the user through electrodes that are grasped by the user to provide an entry voltage into the user and detect an exit voltage through the user's body, wherein the processor calculates the resistance and the reactance of the user based on a detected difference in voltage; or
acquiring the one or more clinical data of the patient through a display by displaying one or more questions provided by the processor, to which the user answers through the keyboard so that his answers are acquired by the processor.

14. The method of claim 10, wherein the step of sending the acquired clinical data comprises sending an SMS containing the acquired clinical data to the diagnostic center.

15. The method of claim 10, further comprising, following the step of receiving the one or more clinical data, contacting the user directly by the diagnostic center through an SMS, a telephone call or a message sent through a display of the piece of equipment.
